(19) United States
(12) Patent Application Publication
(10) Pub. No.: US 2026/0080704 A1
(43) Pub. Date: Mar. 19, 2026

(54) ADAPTIVE DOCUMENT CONTENT EXTRACTION VIA ENTROPY-GUIDED GLOBAL ALIGNMENT

(71) Applicant: Richard Hermann, San Diego, CA (US)

(72) Inventor: Richard Hermann, San Diego, CA (US)

(73) Assignee: Richard Hermann, San Diego, CA (US)

(21) Appl. No.: 19/328,817

(22) Filed: Sep. 15, 2025

Related U.S. Application Data
(60) Provisional application No. 63/695,806, filed on Sep. 17, 2024.

(51) Int. Cl. G06V 30/41; G06N 5/022; G06V 30/418

(52) U.S. Cl. CPC G06V 30/41; G06N 5/022; G06V 30/418

(57) ABSTRACT

A system and method for extracting content from electronic documents, addressing limitations of rigid, template-based approaches and overfitting issues of machine learning approaches are disclosed. The method begins by identifying and ranking content features by Shannon entropy. The highest-ranked feature(s) are used to identify and match “Landmarks”—content that serves as distinct global anchor points for establishing global alignment between documents. With these Landmarks as a foundation, an adaptive, stepwise global alignment process matches the remaining content. This process uses a two-stage technique: deterministic features first identify a set of potential candidate matches, and then non-deterministic spatial features select the single best match from the candidates based on its geometric coherence with already-aligned items. In the final stage, LLMs are selectively employed to generalize the discovered features and relationships into reusable, abstracted prompts. This allows the system to adapt to unseen document formats with higher accuracy than brute force prompting.

### CROSS-REFERENCE TO RELATED APPLICATION

This application claims the benefit of U.S. Provisional Patent Application No. 63/695,806, filed Sep. 17, 2024, the entire contents of which are hereby incorporated by reference.

### FIELD OF THE INVENTION

The present disclosure pertains generally to the field of digital document processing, and more specifically, to systems and methods for the automated extraction, labeling, and structuring of content from documents with varied and inconsistent layouts.

### BACKGROUND OF THE INVENTION

A vast amount of business-critical information is locked within unstructured or semi-structured documents, such as invoices, purchase orders, financial statements, and insurance policies (e.g., PDFs, image files, HTML, spreadsheets). While these documents are designed for human consumption, their variable layouts, structures, and content make them ill-suited for automated data extraction. Their variability creates a significant obstacle to automated content use in workflows, often requiring costly and error-prone manual data entry.

Conventional methods for extracting data from such documents follow two primary paths:
(a) Template-based systems: These systems rely on pre-specified anchors and/or templates to define the location and structure of data to be extracted. However, they are brittle and fail when faced with new document layouts or minor structural variations. Creating and maintaining these templates is a labor-intensive and manual process that does not scale efficiently.
(b) Monolithic machine learning (ML) and Artificial Intelligence (AI) models: While these models offer more flexibility than templates, they have inherent limitations. They often require large, labeled datasets for training and have a tendency to “overfit,” leading to a failure to generalize to new, unseen document layouts. Additionally, certain approaches may suffer from feature collision, where the model cannot distinguish between identical or similar content that appears in different contexts, such as two different values that share the same font and format and are located in similar proximity to each other.

Therefore, a significant technical need exists for a robust, scalable, and efficient system that can accurately and automatically extract unstructured data and semi-structured data from a wide variety of document formats without reliance on rigid templates or extensive document-specific pre-training. Such a system would minimize manual intervention and enable the processing of previously unseen document layouts, overcoming the limitations of conventional methods to provide a scalable and efficient solution to the long-standing problem of automated data extraction.

### SUMMARY OF THE INVENTION

Disclosed herein is a novel system and method for adaptive content extraction that utilizes a core technical framework of entropy-guided global alignment. This approach operates on principles fundamentally different from conventional rigid template matching and monolithic machine learning systems, which are prone to brittleness, overfitting, and a key technical problem known as feature collision.

The process begins by generating a comprehensive feature profile for each Content Item, combining deterministic and non-deterministic attributes. A key aspect of the invention is the use of Shannon entropy to quantify the significance of each feature, thereby creating a data-driven ranked list from most to least discriminating. This ranking enables the system to identify the most distinct Content Items within documents, which intersect between documents. These are labeled as Landmarks which provide a technical solution to overcome the need for manual, pre-specified anchors, particularly for content that lacks a row or column label or where such a row or column label exists in a different row and/or column than content desired to be extracted. Moreover, unlike anchors, Landmarks provide a distinct global alignment point.

The alignment continues with a two-stage adaptive, stepwise global alignment process guided by the entropy ranking. The first stage uses deterministic features to generate a set of candidate matches, while the second stage uses non-deterministic features to select the single best match based on its spatial coherence with the Landmarks. This two-stage method directly addresses feature collision by disambiguating items that may appear identical in a brute-force approach.

The invention also strategically employs Large Language Models (LLMs) for narrow, specific tasks that complement the core alignment. The system leverages a novel feature and content identification process to create reusable extraction prompts, which are then validated by the same alignment process that informed their creation. This establishes a bi-directional validation loop that significantly increases robustness and reliability. By solving these long-standing technical problems, the invention provides a unique and inventive solution for automated content extraction from unstructured and semi-structured documents.

### BRIEF DESCRIPTION OF DRAWINGS

The present invention will become more fully understood from the detailed descriptions and the accompanying drawings, wherein:

FIG. 1 is a flowchart illustrating an exemplary embodiment of the method, illustrating key steps from document reception to structured data output, including, but not limited to matching an incoming document to an existing Document Extraction Set or creating a Document Extraction Set, including the use of an LLM for validation and prompt generation.

FIG. 2 is a block diagram that illustrates the system's architecture, including a user device and a main component that houses key software components for document processing and alignment, such as the features component, Landmark identification component, and adaptive, stepwise global alignment component.

FIG. 3 is an example First Content Document for an investor statement used to show the identification of exemplary Landmarks.

FIG. 4 is an example Second Content Document for an investor statement to show the identification of exemplary Landmarks.

FIG. 5 is an example Second Content Document Variant for an investor statement showing the additional Content Items which cause it to be a variant relative to the First Content Document in FIG. 3 and the Second Content Document in FIG. 4.

FIG. 6 is a table detailing how features are used to determine Landmarks by ranking them based on Shannon entropy to identify the most distinguishing content.

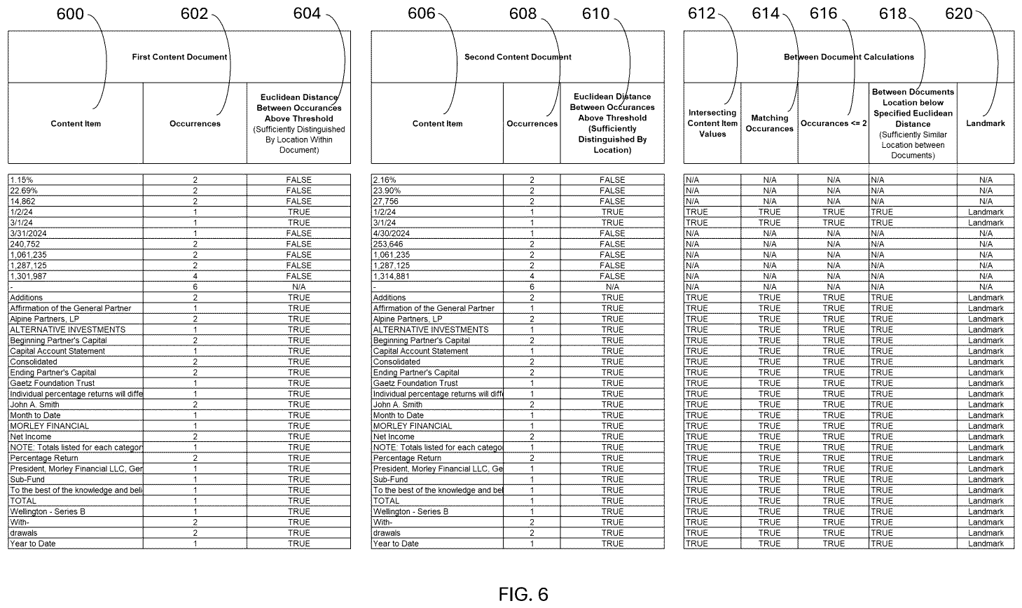

### DETAILED DESCRIPTION OF THE INVENTION

This detailed description, in conjunction with the accompanying drawings, illustrates the principles of a system and method for adaptive content extraction in one embodiment. To provide a comprehensive and enabling disclosure, the description will first define key terminology. It will then describe the system's architecture and constituent components with reference to the figures. Lastly, it will present the specific operational steps of the method, illustrating the interaction between the described components.

The features, advantages, and characteristics described in this specification are not limiting and may be combined in any suitable manner in one or more embodiments. A reference to a particular element, aspect, component, or advantage is understood to mean that it is included in at least one embodiment, but not necessarily in all embodiments. Furthermore, the invention may be practiced without certain described features, and some embodiments may include additional features or advantages not universally present.

As used herein, a “Content Item” refers to a discrete, machine-parsable unit of information from a document. “Content Items” refers to the plurality of “Content Item”. A Content Item may represent a semantic or structural component of the document. Examples of a Content Item include, but are not limited to, a word, a phrase, a paragraph, an image, a table, a data value (e.g., a number or date), or a defined element in a markup language (e.g., an XML element).

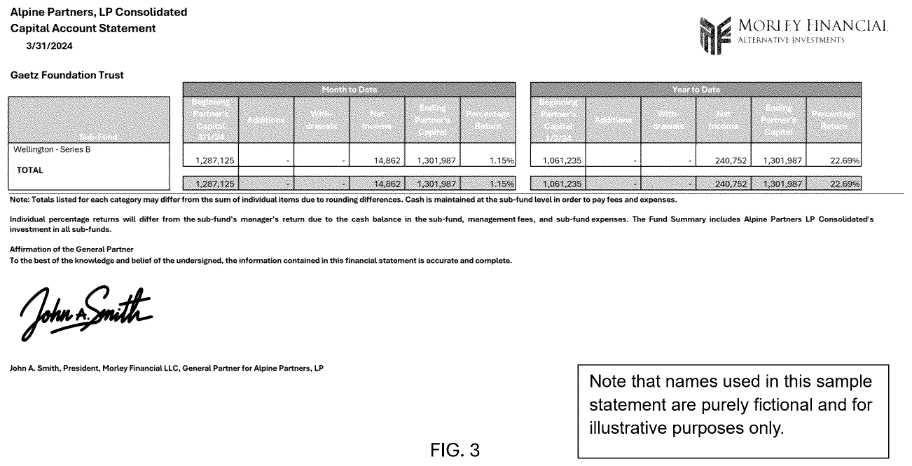

As used herein, a “First Content Document,” shown in FIG. 3, is the initial reference or base document within a group of similar documents and associated alignment and extraction methods referred to herein as a “Document Extraction Set”. The First Content Document serves as the document against which other documents are compared for data extraction. Typically, the first document of a particular type that is processed by the system is designated as the First Content Document. Examples of a First Content Document includes, but are not limited to, the first utility bill, the first invoice, purchase order, financial statement, or insurance policy received by a customer, or other any type of business-critical document first received.

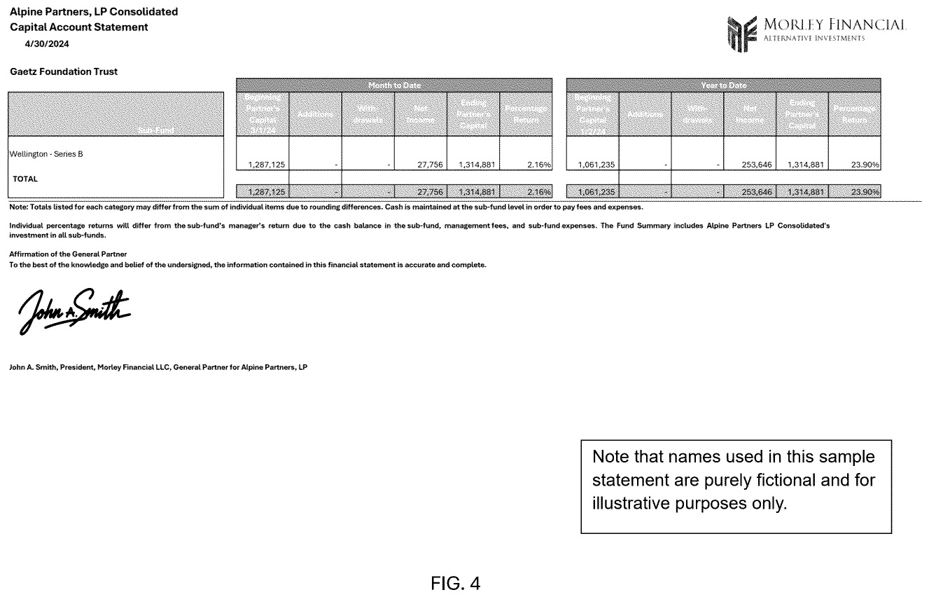

As used herein, a “Second Content Document,” shown in FIG. 4, is an incoming document that is compared against a First Content Document. It is expected to be a routine variation of the First Content Document, containing similar types and location of content but with different value, like a utility bill for a period different than that of the First Content Document.

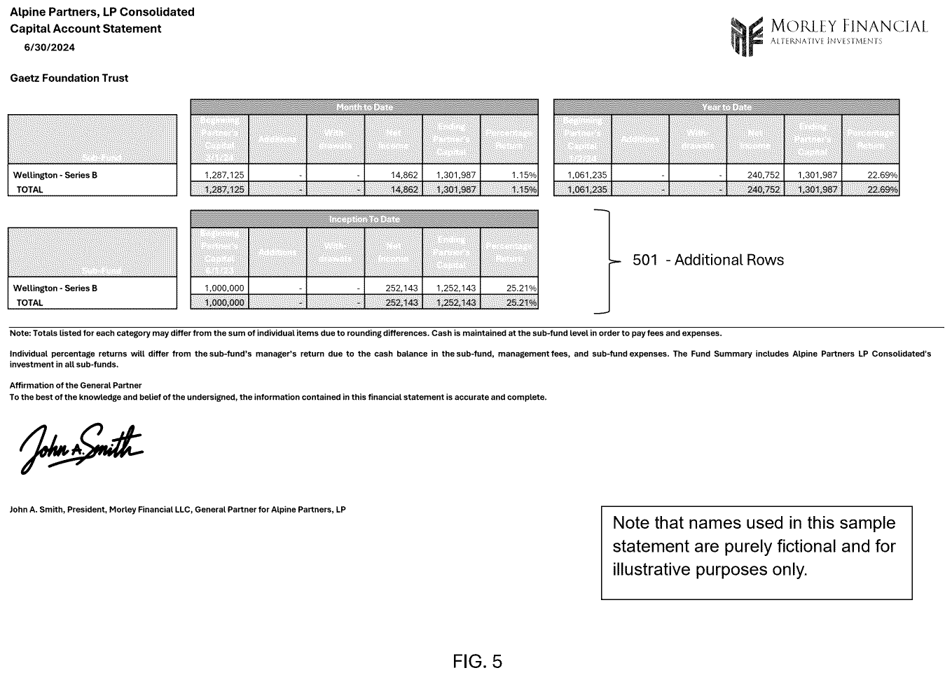

As used herein, a Second Content Document Variant is an incoming document that, while spatially similar to the First Content Document (as measured by a Simplified Procrustes Distance below a predetermined threshold), contains significant structural differences. Its differences relative to a First Content Document are: 1) having a greater or lesser number of Content Items than the First Content Document or Second Content Document, or 2) a change in the order of Landmarks versus a First Content Document. See FIG. 5 for an example of a Second Content Document Variant versus FIG. 3, an example First Content Document. In comparison, see FIG. 4, for an example of a Second Content Document relative to FIG. 3, an example First Content Document, FIG. 3. Note the inclusion of additional rows of content for the Second Content Document Variant that refer to “Inception-to-Date” calculations 501.

As used, herein, a “Landmark” is a distinctive, machine-readable content that serve as distinct, high-confidence global anchor points for establishing global alignment between documents. “Landmarks” refers to a plurality of “Landmark”. Referring to FIG. 3, they are identified and matched between a First Content Document and Second Content Document (or Second Content Document Variant) based on one or more features, particularly those with the highest Shannon entropy scores as described herein. Landmarks are globally distinct within each document based on a combination of features and share similar features between compared documents.

The system and methods disclosed herein utilize a normalized coordinate system to precisely locate elements on a document page. This system uses the document's content area—the region containing all rendered text, images, and other graphical elements—as the reference frame. The top-left corner of this area is defined as the origin (0,0), and the bottom-right corner is (1,1). All coordinate values and measurements, such as height and width, are therefore expressed as relative fractions of the content area's total dimensions.

Where angles are computed, they are normalized to 360 degrees. Thus, 90 degrees is expressed as 0.25 (90 degrees divided by 360 degrees).

The system and methods herein utilize Shannon Entropy to rank features computed on Content Items. Shannon entropy of a given feature, X, which serves as a measure of its uncertainty or information content. A feature with higher entropy is considered more informative and has greater distinguishing power. Shannon entropy as used herein is calculated for a feature X with the following formula:

$$H ( X ) = - {{\sum }_{i = 1}}^{n} p ( {x}_{i} ) {log}_{2} p ( {x}_{i} )$$

Where:
a) H(X) is the entropy of feature X, measured in bits.
b) X is the specific feature (or variable) being analyzed. For example, this could be the “data type” or “format” feature from a document processing system.
c) xᵢ is each unique value that the feature X can take.
d) n is the number of unique values.
e) p(xᵢ) is the probability of observing the unique value xᵢ in the dataset, computed as:

$$p ( {x}_{i} ) = \frac{count of {x}_{i}}{total number of items}$$

f) log₂ is the base-2 logarithm. Using base 2 means entropy is measured in bits, the standard convention in information theory.

To illustrate the application of this formula to features of Content Items, following is an example analysis using a 16-Item Dataset. The entropy calculations for the following set of 16 Content Items with three features (Data Type, Exact Value and Format) to understand their predictive power is disclosed below in Table 1.

TABLE 1

| Content Item | Data Type | Exact Value | Format |
|---|---|---|---|
| Item 1 | CURRENCY | $50.00 | $_XX.XX |
| Item 2 | CURRENCY | $50.00 | $_XX.XX |
| Item 3 | CURRENCY | $50.00 | $_XX.XX |
| Item 4 | CURRENCY | $75.00 | $_XX.XX |
| Item 5 | TEXT | John Smith | Exact |
| Item 6 | TEXT | Beginning | Exact |
| Item 7 | TEXT | Beginning | Exact |
| Item 8 | TEXT | Beginning | Exact |
| Item 9 | CURRENCY | $75.00 | $XX.XX |
| Item 10 | DATE | Jan. 1, 2025 | MM/DD/YY |
| Item 11 | DATE | Dec. 31, 2025 | MM/DD/YY |
| Item 12 | TEXT | beginning | Exact |
| Item 13 | TEXT | ending | Exact |
| Item 14 | CURRENCY | $50 | $_XX |
| Item 15 | CURRENCY | $23 | $_XX |
| Item 16 | DATE | Aug. 24, 2025 | Exact |

This analysis includes the individual features and the combination of ‘Format’ and ‘Data Type’. Combinations including ‘Exact Value’ are excluded.
Using Data Type as an example, start by counting the frequency of each unique value for the Data Type feature.
   CURRENCY: 7 occurrences, TEXT: 6 occurrences, DATE: 3 occurrences
      Total Items: 16
Now, we calculate the probability (p(xᵢ)) for each unique value for Data Type and plug it into the entropy formula.
The probabilities (p(xᵢ)) for each unique value are:

$$p ( CURRENCY ) = \frac{7}{16}$$

$$p ( TEXT ) = \frac{6}{16}$$

$$p ( DATE ) = \frac{7}{16}$$

$$H ( Data Type ) = - [ ( \frac{7}{16} \cdot {log}_{2} \frac{7}{16} ) + ( \frac{6}{16} \cdot {log}_{2} \frac{6}{16} ) + ( \frac{3}{16} \cdot {log}_{2} \frac{3}{16} ) ]$$

$${log}_{2} \frac{7}{16} \approx - 1.19$$

$${log}_{2} \frac{6}{16} \approx - 1.41$$

$${log}_{2} \frac{3}{16} \approx - 2.41$$

$$H ( Data Type ) = - [ ( 7 / 16 \cdot - 1.19 ⊣ ) + ( \frac{6}{16} \cdot - 1.41 ) + ( \frac{3}{16} \cdot - 2.41 ) ]$$

$$H ( Data Type ) = - [ - 1.5013 ] \approx 1.5 bits$$

Similarly, for ‘Format’, we have 7 ‘Exact’, 5 ‘$XX.XX’, 2 ‘MM/DD/YY’, and 2 ‘$XX’.

$$H ( Format ) \approx 1.796 bits )$$

For ‘Exact Value’, we have 11 unique values.

$$H ( Exact Value ) \approx 3.321 bits )$$

For the combination of ‘Format’+‘Data Type’, we have 5 unique pairs.

$$H ( Format , Data Type ) \approx 2.055 bits )$$

A feature with higher entropy provides more information. By calculating the entropy of the relevant feature combinations, we can create a focused ranking of their distinguishing power.

We rank the features and their combinations from most distinguishing to least distinguishing based on their Shannon Entropy.

$$1. Exact Value ( H \approx 3.321 bits )$$

$$2. Format + Data Type ( H \approx 2.055 bits )$$

$$3. Format ( H \approx 1.796 bits )$$

$$4. Data Type ( H \approx 1.505 bits )$$

The systems and methods herein identify Candidate Landmarks within each individual document. The process begins by looping through the top n (a predetermined number) entropy-ranked features on Content Items (e.g., 600, 606), starting with the highest ranked. A feature with higher entropy is considered more informative and has greater distinguishing power. When a highest-ranked feature or combination of features, along with other features computed using the Adaptive Features Database, identifies one or two distinct Content Items (e.g., Content Items 602, 608), those Content Items are defined as “Candidate Landmarks” for that document.

Candidate Landmarks are validated as a Landmark when they meet all of the following criteria:
a) Candidate Landmarks with the same value, that occur twice within a document exist in sufficiently different locations. Such difference in locations is measured by their (x,y) locations being above a predetermined threshold as measured by Euclidean distance (e.g., 604, 610),
b) The exact value of the Candidate Landmarks are equal (e.g., 612);
c) Candidate Landmarks share a similar location between documents, as measured by Euclidean distance being within a predetermined threshold; (e.g. 618)
d) each shares the same number of occurrences 614 (one or two 616); and
e) their locations are not outliers, as defined by a Mahalanobis distance that is greater than a threshold.
   This process of identifying Landmarks by intersection provides the foundation for the adaptive, stepwise global alignment of documents.

In one embodiment, a heuristic is used in lieu of Shannon entropy for identifying Landmarks. This heuristic is taking the intersection of unique value Content Items from each document, subject to the following conditions:
f) Content Item's value occurs 1 or 2 times in each document (either 1 time in each document or 2 times in each document)
g) Pairs of occurrences between documents are located in similar locations within each respective document (e.g., first occurrence in First Content Document is located at (0.25,0.38), first occurrence in Second Content Document Variant is located at (0.24,0.37) and second occurrence in First Content Document is located at (0.43,0.39) and second occurrence in Second Content Document Variant is located at (0.44,0.41). Similar location is defined to be a location within a predefined threshold of Euclidean distance.
h) Occurrences within each document are spatially different within each document. Using Euclidean distance those Content Items with a location as measured by Euclidean distance being above a predefined threshold are considered to be spatially different.
i) The feature's location is not an outlier, as determined by the Mahalanobis distance.

In a preferred embodiment, a Simplified Procrustes Distance (Procrustes Distance Without Rotation) is used to identify similar documents. Procrustes Distance is a statistical method used to measure shape similarity after aligning two sets of points (or shapes) by finding the optimal similarity transformation (translation, scaling, and rotation) that minimizes the distance between them. In the simplified version utilized in the systems and methods described herein, it is assumed that both sets of points already have the same orientation, so the rotational component is assumed to be zero. With this assumption, the goal of the Simplified Procrustes Distance is to find only the optimal uniform scaling factor s and translation vector t to best align the set of points Y (Landmarks from Second Content Document) to a corresponding set of points X (Landmarks from First Content Document) and then such (aligned) location points for Landmarks are utilized to assess the degree of their similarity in overall location. The following details the computation for the Simplified Procrustes Distance and its application to similarity of Landmark points.
a) X defines the target shape (First Content Landmark points).
b) Y defines the source shape (Second Content Landmark points).
c) The calculation seeks to find a scalar s and a translation vector t that minimize the sum of squared differences, D, between the points of X and the transformed points of Y. The objective function is defined using the squared Frobenius norm:

$$D ( s , t ) = {‖ X - ( sY + 1 {t}^{T} ) ‖}_{F}^{2}$$

where 1 is an n×1 vector of ones, and t is a k×1 vector representing the translation. To simplify the problem, we first remove the translational component by centering both shapes at the origin. We compute the centroid (mean position) for each shape.
d) The centroid of the target shape X is:

$${c}_{X} = ( \frac{1}{n} ) {\sum }_{i = 1}^{n} {x}_{i} = ( \frac{1}{n} ) {X}^{T} 1$$

The centroid of the target shape Y is:

$${c}_{Y} = ( \frac{1}{n} ) {\sum }_{i = 1}^{n} {y}_{i} = ( \frac{1}{n} ) {Y}^{T} 1$$

e) We then create centered matrices, X₀ and Y₀, by subtracting the centroids from their respective points:

$${X}_{0} = X - 1 {c}_{X}^{T}$$

$${Y}_{0} = Y - 1 {c}_{Y}^{T}$$

f) With the shapes centered, the objective function simplifies to finding the optimal scaling factor s that minimizes the distance between X₀ and sY₀.

$$D ( s ) = {‖ {X}_{0} - {sY}_{0} ‖}_{F}^{2}$$

g) To find the minimum, we take the derivative of D(s) with respect to s and set it to zero. The objective function can be expanded using the trace operator:

$$D ( s ) = trace ( {( {X}_{0} - {sY}_{0} )}^{T} ( {X}_{0} - {sY}_{0} ) ) = trace ( {X}_{0}^{T} {X}_{0} ) - 2 s \cdot trace ( {X}_{0}^{T} {Y}_{0} ) + {s}^{2} \cdot trace ( {Y}_{0}^{T} {Y}_{0} )$$

h) Taking the derivative with respect to s:

$$\frac{d D}{d s} = - 2 \cdot trace ( {X}_{0}^{T} {Y}_{0} ) + 2 s \cdot trace ( {Y}_{0}^{T} {Y}_{0} ) = 0$$

i) Solving for s, we get the optimal scaling factor:

$$s = \frac{trace ( {X}_{0}^{T} {Y}_{0} )}{trace ( {Y}_{0}^{T} {Y}_{0} )} = \frac{{\sum }_{i = 1}^{n} ( {x}_{0 i} \cdot {y}_{0 i} )}{{\sum }_{i = 1}^{n} {‖ {y}_{0 i} ‖}^{2}}$$

j) Once the optimal scaling factor s is known, the optimal translation vector t is calculated to align the centroids of the scaled source shape and the target shape.

$$t = {c}_{x} - s \cdot {c}_{Y}$$

k) The final aligned source shape Y′ is given by:

$${Y}^{′} = sY + 1 {t}^{T}$$

After performing the alignment, the minimized distance Dₘᵢₙ between the target shape X and the optimally transformed source shape Y′ is known as the Simplified Procrustes Distance. In a preferred embodiment, it serves as a measure of similarity between the two initial sets of Landmarks, which is in turn, utilized a proxy for document similarity.

$$D\_min = {‖ X - {Y}^{′} ‖}_{F}^{2} = {‖ X - ( sY + 1 {t}^{T} ) ‖}_{F}^{2}$$

A smaller Simplified Procrustes Distance indicates a higher degree of similarity. To make a binary decision on the similarity of Landmark points, the Simplified Procrustes Distance is compared to a predefined threshold. If the Simplified Procrustes Distance is less than or equal to the predefined threshold, the Landmark points are considered spatially similar. This provides strong evidence that the documents share a similar underlying structure or layout in the positioning of Landmarks. This measure is important for two purposes: 1) identifying a corresponding First Content Document among potential candidates when a new document is received, and 2) identifying whether a document is sufficiently similar to a First Content Document, even if it has attributes that differ from a Second Content Document (such as differing rank order of Landmarks as described herein), thereby classifying it as a Second Content Document Variant.

In a preferred embodiment, Mahalanobis Distance is applied to remove outlier Landmarks before computing Simplified Procrustes Distance. In the context of document alignment, when Landmarks are used as anchor points to create global alignments between two documents, a problem potentially arises when some Landmark pairs are spatially inconsistent with the majority of other pairs. These spatial outliers can negatively impact the calculation of location similarity and result in poor alignment. To address this, the Mahalanobis Distance is applied to the Landmarks to eliminate outliers. This technique is considered more robust because it accounts for the correlations between variables, unlike methods that look at each variable independently. This is because the Mahalanobis Distance quantifies how many standard deviations a data point is from the distribution's center (mean), considering the overall shape and orientation of the data.

As used herein, Mahalanobis Distance is calculated by the following formula:

$${D}^{2} = {( x - μ )}^{T} * {S}^{- 1} * ( x - μ )$$

Where:
a) D² is the squared Mahalanobis Distance for a specific data point.
b) x is the vector for the data point being evaluated (e.g., [x1, x2, . . . , xp] for a point with p variables).
c) μ is the mean vector (or centroid) of the dataset, which represents the average value for each variable.
d) S⁻¹ is the inverse of the dataset's covariance matrix. The covariance matrix (S) defines the variance within each variable and the covariance between pairs of variables.
e) (x−μ)^{T} is the transpose of the difference between the data point vector and the mean vector.

The process of removal of an outlier in one embodiment is accomplished by the following steps:
a) Calculate the Centroid (μ): The mean vector is calculated to serve as the center of the data distribution.
b) Determine the Covariance Matrix (S): The covariance matrix is calculated to understand the shape and orientation of the data.
c) Compute the Mahalanobis Distance: The squared Mahalanobis Distance (D²) is calculated for each data point from the centroid.
d) Set a Threshold: A threshold is established to classify which points are outliers. This is often done by comparing the D² values to a critical value from a chi-squared (χ²) distribution. The degrees of freedom for this distribution are equal to the number of variables in the dataset.
e) Identify and Remove Outliers: Any data point with a D² value that exceeds the chi-squared critical value is identified as an outlier and can be removed.

After Landmarks are identified using Shannon entropy, any outlier Landmarks are removed when the Mahalanobis Distance for the location of a Landmark exceeds a predetermined threshold.

As used in a preferred embodiment, a novel method for determining the geometric coherence between two or more Content Items based on their spatial relationship to a set of Landmarks is disclosed. This method, hereinafter referred to as the “Hough-Inspired KNN Similarity Feature”, utilizes principles analogous to the Generalized Hough Transform, an algorithm employed in computer vision to identify congruent shapes by leveraging geometric properties such as distance and angle. The Hough-Inspired KNN Similarity Feature provides a non-deterministic score that quantifies the spatial consistency of a candidate Content Item's location relative to Landmarks within a document as compared to the location of a Content Item in a compared document relative to the Landmarks in the compared document.

To compute the Hough-Inspired KNN Similarity Feature for a given Content Item, a first step is to identify the K-Nearest Neighbor Landmarks. Given a Content Item C located at position (x_{C}, y_{C}) and a set of N Landmarks L={L₁, L₂, . . . , L_{N}}, where each Landmark Lᵢ is at a position (x_{L}_{ᵢ}, y_{L}_{ᵢ}), the K Landmarks nearest to C are identified. The proximity of each Landmark to C is measured using the Euclidean distance d(C, Lᵢ), which is computed according to the following formula:

$$d ( C , {L}_{i} ) = \sqrt{{( {x}_{{L}_{i}} - {x}_{C} )}^{2} + {( {y}_{{L}_{i}} - {y}_{C} )}^{2}}$$

The K Landmarks yielding the smallest Euclidean distance values are selected to form the set of K-Nearest Neighbor Landmarks.

Subsequently, a Spatial Signature Vector is constructed from the K-Nearest Neighbor Landmarks. This vector is a single, high-dimensional representation that encodes the directed angle and distance from the Content Item C to each of its K-Nearest Neighbor Landmarks. For each of the K selected Landmarks Lⱼ (where j=1, . . . , K), two scalar values are computed by the following calculations:
a) The distance dⱼ: The Euclidean distance from C to Lⱼ, as computed above.
b) The directed angle thetaⱼ: The angle of the vector originating at C and terminating at Lⱼ, computed using the arctangent function on the difference in their coordinates. The angle is expressed in radians from the positive x-axis.
c) The Spatial Signature Vector S_{C} is a concatenation of these ordered pairs and has a total of 2K dimensions:

$${S}_{C} = [ {theta}_{1} , {d}_{1} , {theta}_{2} , {d}_{2} , … , {theta}_{K} , {d}_{K} ]$$

The Hough-Inspired KNN Similarity score between a first Content Item C_{A} and a second Content Item C_{B} is then determined by calculating the similarity of their respective Spatial Signature Vectors, S_{C}_{_{A}} and S_{C}_{_{B}}. This is accomplished by Euclidean distance between both vectors. Importantly, note that this is not simply Euclidean distance from the location of a Content Item to the nearest Landmarks. In contrast, it utilizes angles and distance from a Content Item to Landmarks. This distinction is considered a key part of the disclosed methods, providing greater robustness against positional variations that commonly occur in documents and cause simple Euclidean distance measures to fail.

As utilized herein, Euclidean distance refers to the straight-line spatial distance between two points in a Euclidean space. This metric is a standard measure used to quantify the dissimilarity or difference between data points, features, or vectors. In an n-dimensional space, the Euclidean distance between two points, P and Q, is calculated by taking the square root of the sum of the squared differences of their corresponding coordinates. The formula for Euclidean distance is:

$$d ( P , Q ) = \sqrt{{\sum }_{i = 1}^{n} {( {p}_{i} - {q}_{i} )}^{2}}$$

Where:
   a) d(P, Q) represents the Euclidean distance between points P and Q.
   b) P=(p₁, p₂, . . . , pₙ) and Q=(q₁, q₂> . . . , qₙ) are two points in n-dimensional space.
   c) pᵢ and qᵢ are the coordinates of points P and Q along the i-th dimension.

$$\begin{matrix}d ) & \\ {\sum }_{i = 1}^{n} & \end{matrix}$$

indicates the sum from the first dimension (i=1) to the n-th dimension.
e) (pᵢ−qᵢ)² is the squared difference between the coordinates of the two points in the i-th dimension.

According to an exemplary embodiment, a system for extracting content from electronic documents is disclosed. In one aspect, the system is configured for generating a feature profile for a plurality of Content Items extracted from electronic documents. The profile enables robust matching of corresponding Content Items across document variants, even with variations in layout, formatting, and content ordering. In one embodiment, a method for generating a feature profile for a plurality of Content Items is disclosed, which comprises the steps described herein. The generated feature profile, or signature, includes both deterministic and non-deterministic features to inform and refine the alignment at each stage and is comprised of several categories of features as components of the present embodiment. Deterministic features are discrete attributes utilized for exact-match comparisons. In some aspects, these features are employed in a primary matching stage to generate an initial set of candidate matches between Content Items.

Exact value is the first deterministic feature used. In one embodiment, this is the string representation of the Content Item (e.g., “Acme Corp.”, “1,234.56”). This feature provides the highest level of specificity for a Content Item. For non-textual content, this could be an image hash or the code which renders an image such as SVG. In each instance, it represents an exact value for the Content Item. Equivalence may also be established where variance after normalization is below a predefined threshold (e.g., a rendered image scaled by 98% versus the same image at 100% is considered to have the same exact value). Similarly, a percentage calculation may be computed Content Items identified, for use in the following formula:

$$return = \frac{Ending Market Value}{Beginning Market Value} - 1$$

Such a calculation may return a result that is within rounding distance of another value being compared. In one embodiment, this would be considered an exact value match.

Relational features are the second deterministic feature used: Relational features are logical or mathematical relationships between a plurality of Content Items which are encoded as a feature. For instance, if three numerical Content Items (A, B, C) satisfy the equation A+B=C, this formulaic relationship is identified. Then, each item is assigned a role using one-hot encoding to represent its place or role in an equation (e.g., [1,0,0] for operand A, [0,1,0] for operand B, and [0,0,1] for result C).

Evidence-based features are the third deterministic feature used. These features are informed by new information in a similar way to Bayesian inference. Such features are iteratively refined by a process of hypothesis testing. For example, in an investor statement, a formula for ‘Ending Market Value’ might be ambiguous as to whether withdrawals are subtracted are the beginning or end of a period when computing the percentage return for the period. This is often the case because, in most periods following an investment, withdrawals are not made (i.e., have a zero value). The ‘prior belief’ in such a case may be the assertion that withdrawals are subtracted at the beginning of a period. Upon processing a document with new evidence (a non-zero withdrawal), the system resolves the ambiguity in the following manner. The method calculates the formula under both assumptions and compares the results to the document's actual values. The validated assumption updates the formula to a more accurate ‘posterior belief’, which becomes the new ‘prior belief’ for subsequent analyses. For example, a formula is revised from

$$return = \frac{Ending Market Value}{Beginning Market Value - Withdrawal} - 1$$

$$return = \frac{Ending Market Value - Withdrawal}{Beginning Market Value} - 1$$

In this embodiment, the evidence-based feature is revised from the prior formula to the new formula and each variable in the formula corresponding to a Content Item in a document is one-hot encoded as a new relational feature.

Converted features are the fourth type of deterministic feature used. These features are non-deterministic features which are converted into deterministic features. In one embodiment, to leverage spatial information deterministically, certain non-deterministic metrics are converted into deterministic features (discrete Boolean features). For example, if the difference in the normalized vertical positions of two Content Items is within a tolerance threshold, a deterministic Boolean feature, “is_on_same_line”, is assigned a value of TRUE or FALSE and is one-hot encoded as a converted feature.

Non-Deterministic features are the second group of features. These capture spatial and relative attributes. They are not used for initial candidate generation but for second-stage disambiguation to select the correct match from a list of candidate matches. Such features include, but are not limited to spatial metrics, including the size of the Content Item (e.g., bounding box area), the Euclidean distance to other nearby Content Items, and the distance and angle relative to identified page Landmarks.

In a preferred embodiment, the “Hough-Inspired KNN Similarity Feature” is used as a non-deterministic feature. The advantage of this approach over conventional KNN methods is its use of a spatial signature that incorporates both angle and distance, providing a more specific geometric constraint than distance alone. For example, consider two Content Items, which share the same set of K-Nearest Neighbors (KNN). In contrast, to KNN the Hough-Inspired KNN Similarity Feature will not be equal because of the difference in angles and distances to Landmarks. Thus, this approach provides a more robust alignment mechanism than nearest neighbor approaches.

In a preferred embodiment, the system and methods utilize a two-stage approach to the use of deterministic and non-deterministic features. The first stage uses deterministic features to compile an exhaustive list of all potential candidates sharing a specific trait (a high-recall step). The second stage then uses non-deterministic features to precisely select the single correct match from that list (a high-precision step), which drastically reduces false positives.

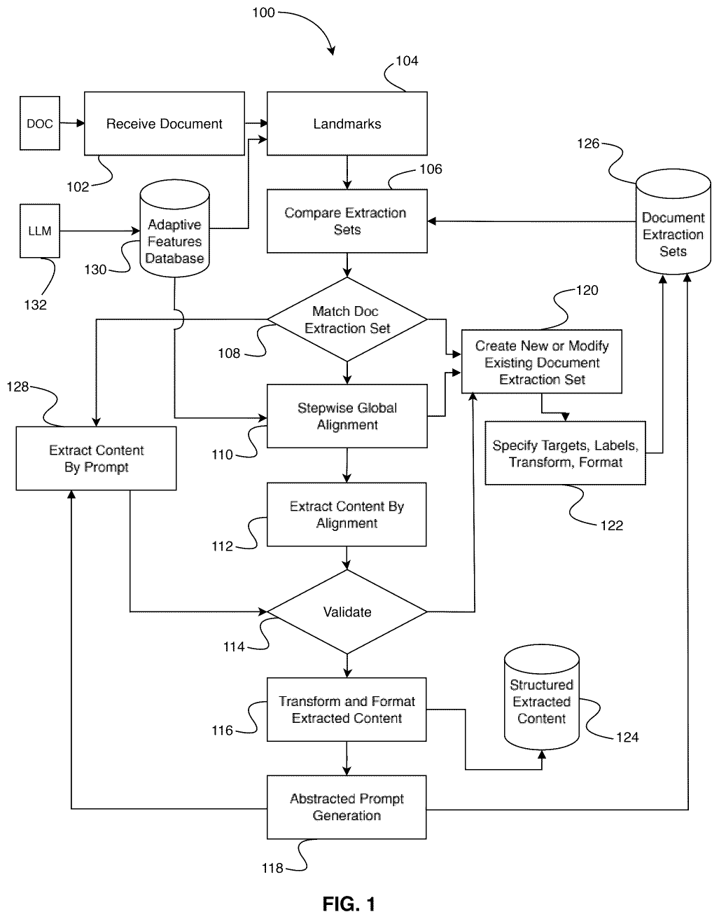

In a preferred embodiment, the system includes an adaptive features database 130, as shown in FIG. 1, which comprises a repository of candidate features, and the logic required for their computation. The features within this database 130 are indexed and organized according to Content Item type (e.g., number, date, percentage, DOM node in HTML document, spreadsheet cell, etc.) and document type (e.g., PDF, spreadsheet, HTML, Image, etc), enabling the dynamic selection of one or more relevant features for any given piece of content.

In this way, the type-specific architecture allows for a nuanced and accurate feature extraction process. For example, when processing a composite document such as a PDF, the system identifies distinct Content Items within it—such as text blocks and embedded images—and retrieves from the database 130, separate feature sets tailored specifically for textual analysis and image analysis, respectively.

In another example when processing a spreadsheet document, the feature vector for a spreadsheet cell is not limited to merely its rendered numeric or text value. The adaptive features database 130 defines additional structural and semantic features, including, but not limited to: a) the cell's absolute grid coordinates (e.g., row and column identifiers), b) the underlying formula used to compute the cell's value, if present and c) formatting attributes or embedded objects within the cell. The inclusion of the underlying formula as a feature is particularly advantageous. For instance, the formula can be one-hot encoded. This allows the system to match corresponding cells across different documents by comparing their underlying formulas, even when the calculated values appear different. In doing so, this method provides a more robust basis for document comparison than relying on rendered or computed content alone.

Thus, in operation, the system first identifies the type of a given Content Item (e.g., image, text, spreadsheet cell, HTML Node) and subsequently queries the adaptive features database 130 to retrieve the specific set of features and computation methods prescribed for the content type associated with a Content Item.

In a preferred embodiment, disclosed is a method and system for the adaptive hierarchical standardization component of certain values of a Content Item beyond exact value. Such method and system receive a Content Item and progressively generalizes said Content Item into a hierarchy of increasingly abstract categories. The process utilizes a data store of transformation rules and a deterministic, multi-level algorithm to map a specific data value to a structural class and subsequently to a broader semantic class. This facilitates the semantic matching of data objects that are syntactically different but semantically equivalent.

The core of this hierarchical standardization is a set of transformation rules stored in a data store, such as a database or an in-memory data structure. Each rule within the set of transformation rules is a data structure defined by a plurality of attributes. In an embodiment, said attributes comprise:
a) a unique identifier for referencing the rule, and
b) a matching pattern which constitutes the logic for identifying a particular Content Item. In a preferred embodiment, this is a Regular Expression (RegEx), configured to identify a specific data format within a Content Item,
c) a standardized class name to be assigned to a Content Item determined to conform to the matching pattern. (e.g., the format MM/DD/YYYY) corresponds to a class called ‘DATE_MM/DD/YYYY’,
d) an identifier that links the rule to a superordinate class in a predefined hierarchy, thereby creating a relationship to a broader category. In other words, the Parent Class Identifier for MM/DD/YYYY would be DATE,
e) a numerical value, representing specificity level; for instance, an integer, indicating the rule's precedence during evaluation. Rules with a higher specificity level are configured to be evaluated before rules with a lower specificity level.

For illustrative purposes, a rule may be configured to identify United States currency formats (e.g., \hat{ }$\d{1,3}(,\d {3})*.\d{2}$), assigning a Class Identifier of CURRENCY_USD and linking to a Parent Class Identifier of CURRENCY. Another rule may be configured to identify date formats (e.g., \hat{ }(0 [1-9]|1 [0-2])/(0[1-9][12]\d|3 [01])\\d{4}$), assigning a Class Identifier of MM/DD/YYYY and linking to a Parent Class Identifier of DATE.

In a preferred embodiment, several formats for dates are utilized with a parent class, ‘DATE’. Thus, if two dates exist within a document with differing formats, the hierarchical standardization will identify their difference within documents. Thus, the date Oct. 21, 2025 and the date 1/1/25 will be standardized as “MMM dd, YYYY” and “MM/dd/YY” respectively in the hierarchical standardization. If a Second Content Document Variant has the same date formats, as in the case of “Nov. 19, 2025” and “12/14/25”, these will be standardized as “MMM dd, YYYY” and “MM/dd/YY” respectively in the hierarchical standardization.

In a preferred embodiment, a method for standardizing a Content Item by value is performed by one or more processors executing instructions stored on a non-transitory computer-readable medium. The method comprises the following steps:
a) a Content Item is evaluated by the one or more processors for classification. For example, the system may receive evaluate the text “09/17/2025” from a First Content Document and the text “Dec. 15, 2025” from a Second Content Document,
b) a query is performed against a pre-compiled lookup table or data store of known specific values to determine if an exact match for the Content Item exists. If said exact match is found, a pre-associated class identifier is returned, and the process may terminate,
c) If no exact match is found in the preceding step, the system proceeds to iterate through the set of hierarchical standardization rules. The iteration is ordered according to the Specificity Level, from highest to lowest. For each rule, a determination is made as to whether the Content Item conforms to the rule's matching pattern. For the exemplary input “09/17/2025” AND “12/15/25”, the system would identify a match by standardizing each with the rule corresponding to the MM/DD/YYYY date format. Upon identifying a matching rule, the system assigns the corresponding Class Identifier (Date_MM/DD/YYYY) to the Content Item. When two Content Items are compared and both have the same Class Identifier (in this example, Date_Date_MM/DD/YYYY), the pair of Content Items become candidate matches which are later checked for non-deterministic similarity in the adaptive, global stepwise matching process. Note that this is only the first step of matching-pass must pass a non-deterministic similarity check, described herein to be matched between documents.

In a preferred embodiment, one or Content Items of greater complexity, such as a full postal address, the matching process may involve composite rules wherein a primary rule invokes a plurality of dependent sub-routines or rules to parse and identify constituent parts (e.g., STREET_ADDRESS, CITY, STATE, ZIP_CODE) prior to assigning a final structural class.

In a preferred embodiment, the systems and methods are designed to be adaptive so that there is a mechanism for updating the hierarchical standardization rule set based on new, unrecognized values for Content Items. This is accomplished through
a) failure logging-when a Content Item fails to match any rule in the existing set (other than a catch-all), it is logged as “unclassified” and flagged for review,
b) periodic rule generation where a system administrator or a LLM reviews batches of unclassified items to classify them, if they are regarded as similar,
c) human input or LLM input to manually construct a new rule (defining the Pattern, ClassName, ParentClass, and Specificity Level) to handle it and similar future items,
d) a machine learning component can cluster similar unclassified items and suggest a new regular expression and classification, which is then approved by an administrator before being added to the active rule set. By systematically expanding the system's classification capabilities through additional hierarchical categories without requiring a code change the system can evolve and improve its accuracy and coverage as it is exposed to new and varied data formats which are translated into new rules.

In a preferred embodiment, Content Item values may also be standardized through specific values. These can consist of:
a) external-based values,
b) membership in a known or discovered set of choices, or
c) predicted value.

For external values, Content Item's identity is confirmed by querying its value against a curated data store of known entities, often referred to as a gazetteer. For example, a text value is checked against a database of known company names, security identifiers, or industry-specific codes to assign it a specific categorical feature. The invention maintains such a gazetteer of related knowledge (e.g., customer names, addresses, investment vehicles), storing each with its associated label and known variants (e.g., “John Smith” and “John P. Smith” are both labeled and stored as “CustomerName”).

In a preferred embodiment, the disclosed system and method determines if the value of a Content Item belongs to a set of categorical choices derived from historical data. The potential values contained in this set for a Content Item are referred to as a “Choice Set”. The system constructs and expands this choice set in the following way. Initially, the system may have a Content Item with the value of ‘Approved’. Upon encountering a Content Item, with a value such as ‘Pending’, which exists in a similar location as measured by the non-deterministic location similarity measures such as Hough-Inspired KNN Similarity Feature, the newly discovered value is submitted to a large language model (LLM) for evaluation of sematic relatedness. If the LLM confirms that the newly discovered value is related, it is automatically added to the Choice Set. The Choice Set itself is one-hot encoded to differentiate it from other Choice Sets in the document and to allow specific value standardization for that Content Item (e.g. ‘Pending’ and ‘Approved’ would be standardized to a single one-hot encoded value, ‘Status’). Additionally, the specific value (‘Approved’ or ‘Pending’) itself is stored such that it may be extracted. In this way, ‘Approved’ and ‘Pending’ are able to be aligned because of their standardized value (and location similarity). Moreover, actual extraction of the actual Content Item values (‘Approved’ in one document and ‘Pending’ in another document) are enabled. A key inventive aspect of this process is its ability to identify relatedness of the values of Content Items rather than (lexical or non-lexical) similarity. In the above example, ‘Pending’ is semantically linked to ‘Approved’ but lexically dissimilar. The use of a LLM to specifically identify relatedness overcomes the limitations of conventional similarity-based methods that would fail to recognize such a relationship, thereby providing a more robust and accurate method for handling previously unseen categorical data.

For illustration, in the context of the example Content Items in the preceding paragraph, provided is an example prompt for a LLM:
As a specialized AI tasked with evaluating the semantic relatedness of categorical data, you will be given an ‘existing value’ and a ‘new value.’ Your sole purpose is to determine if the ‘new value’ is semantically related to the ‘existing value’ in the context of a potential set of choices. This means they could be different categorical options for the same type of data. Given the input:

{
“existing_value”: “Approved”,
“new_value”: “Pending”
},

is “Pending” semantically related to “Approved” as a potential categorical choice within a single data field?
Your response must be a single Boolean value (true or false) with no additional text, explanation, or punctuation. For example, if the answer is ‘true,’ your entire response should be true.

In another preferred embodiment, the disclosed system and method standardizes Content Item values by prediction, based on relationship to other Content Items or based on document properties (herein referred to as relationship value standardization). For example, if a document Content Item is a date, and that date has a value that occurs a month-end and this is the first month-end date that occurs after a document's creation date (stored in the documents metadata), this becomes encoded as predicted value. For example, a First Content Document created on Apr. 18, 2025 containing a date, Mar. 30, 2025, would have a predicted value of “predicted: last month-end value preceding document creation date”. A Second Content Document Variant, created on Oct. 10, 2025 would be evaluated for the same predicted feature and searched for a Content Item with a value “predicted: last month-end value preceding document creation date” calculated to be Sep. 30, 2025. If two Content Items between documents share this feature (among other deterministic features) and are located in a similar locations based on the non-deterministic features described herein, relative to their position on a document, these two are matched in the alignment process.

A system and method are disclosed for quantitatively analysing and ranking features of Content Items within a document or a collection of documents to identify the most distinguishing content. In one embodiment, the system is configured to calculate the Shannon entropy for a plurality of features to determine their respective information content and thereby their predictive power. Such ranking is used both within the determination of Landmarks, and in informing the order of the adaptive, stepwise global alignment of Content Items. Ranking features by entropy provides a more efficient means of identifying the most unique Content Items as Landmarks (automatically identified global anchor points within a document). Additionally, such ranking by entropy informs the order of adaptive, stepwise global alignment of items so that generally, the most unique items are matched before less unique items within the global alignment (of Content Items).

In a preferred embodiment, Content Items between documents are compared to identify cases where a single Content Item in one document might have been split into two or more adjacent positions in the other document (e.g., for text, “Account Number” may exist in one document vs. “Account” and “Number” existing adjacent to each other in another document). Where Content Items are able to be concatenated from one document to match single Content Items in another document, these Content Items are concatenated.

In a preferred embodiment, a key aspect of the system and methods described herein is the order of performing the adaptive, stepwise global alignment of Content Items. This key aspect insures that such an alignment is conducted in steps by matching more specific, more unique Content Items before matching less specific, more general Content Items. In this context, Shannon entropy is utilized to determine the ordering of the adaptive, stepwise global alignment so that the process proceeds from higher specificity (higher entropy) features to more general (lower entropy) features. In a preferred embodiment, the process involves iterative alignment of Content Items contained in a First Content Document and a Second Content Document Variant, carried out as follows.

After identifying Landmarks, as described herein, the system then iteratively attempts to match the remaining unmatched Content Items a step at a time. The iterative matching proceeds in accordance with the ranked feature list, progressing from highest to lowest entropy so that the stepwise matching progresses from more specific matches to less specific matches. In each iteration, all available features are utilized, including lower-ranked deterministic features and non-deterministic spatial relationships to previously matched items. This approach provides advantages including improved accuracy of matches due to progressive refinement, and efficiency in resolving items based on available structural and contextual information. As additional items are matched, their spatial and structural relationships form a dynamic contextual web. This contextual web provides additional constraints and cues, thereby improving the accuracy of subsequent matching decisions. Because matching is performed without replacement, the pool of candidate items available for matching progressively decreases. This shrinkage in candidate space increases both the speed and reliability of subsequent matches.

In the final step, the system evaluates similarity across all features except standardized values. After Content Items have been matched through the various Content Value standardizations combined with deterministic and non-deterministic features (as described above), any remaining unmatched Content Items undergo additional assessment. This assessment process involves two stages:
(a) First, the system evaluates similarity across deterministic and non-deterministic features while excluding Content Item values (standardized or otherwise) from consideration.
(b) Second, Content Item values are analysed using either a Large Language Model (LLM) or human input to identify semantic relatedness (as distinguished from similarity as described herein when Choice Set is discussed).

In a preferred embodiment, where Landmarks exist in differing order in a Second Content Document Variant, an LLM is prompted to provide labels for Content Items. Differing order is defined as a change in the rank order of the vertical or horizontal coordinates of at least two corresponding Landmarks between the First and Second Content Document Variants. Where such LLM prompting is used for specific labeling of content, labels are one-hot encoded as deterministic features as described herein.

In some embodiments, the method incorporates narrow, targeted use of LLMs. Unlike conventional systems that rely extensively on LLMs for brute force parsing, the present invention employs LLMs selectively within defined stages of the method. In certain embodiments, LLMs are applied in four specific cases, described as follows.

Validating New Content: In one case, an LLM is used for verifying new information 114 that the system discovers. Such verification is particularly relevant for content that is semantically related, as described when discovering new content for inclusion in a Choice Set 120.

New Content Labeling: In another case, an LLM is used for labeling newly identified content types to enrich the system's knowledge base. For example, if a “cc'd email” is identified as a new, unmatched Content Item relative to a First Content Document, the LLM may assign the label “cc email address” or an equivalent designation 120.

Constrained Labeling of Reordered Content: In some embodiments, when ordering of Landmarks between the First Content Document and the Second Content Document Variant is inconsistent, an LLM is employed to assign labels 130 to the content. This labeling is performed as a prompt feature within the adaptive features database 130. In operation, a canonical label set is first generated from a source document. When processing a variant, the LLM is technically constrained to assign labels only from the predefined canonical set. If unmatched content is encountered, the LLM assigns a label beginning with “new label:” followed by a description. For example: “new label: YTD return.” This constrained, forced-choice classification process overcomes the non-deterministic tendencies of unconstrained LLMs. The generated labels for both the First Content Document and the Second Content Document Variant are then one-hot encoded as deterministic features, ensuring robust and consistent representation between the documents.

Abstracted Prompts: In further embodiments, an LLM is prompted 118 to generate an abstracted prompt for LLM extraction. Such prompts may be generated for groups of related First Content Documents, Second Content Document Variants, and second content variants.

Relationships Discovered: In additional aspects, relationships discovered during the process include, but are not limited to: (i) identifying formulaic relationships between numbers which may be used as features 132, and (ii) expanding the categories used for standardization, thereby expanding hierarchical features 132.

In a preferred embodiment, the system employs a bi-directional validation of any prompts generated across Document Extraction Sets. This is referred to as a Bi-Directional Prompt Validation as described next. Abstracted prompts developed using an LLM are validated 114 via the same content matching process that preceded prompt creation. Thus, such abstracted prompts are tested individually, on sample First Content Documents, Second Content Document Variants and their variants using the adaptive, stepwise global alignment process described herein along with their corresponding Document Extraction Sets.

Where prompts fail to extract content accurately in this test phase, they are iteratively 1) manually altered or 2) sent to an LLM for revision (120). If no prompt is successfully identified after multiple iterations, this is noted in the Document Extraction Set (126) and subsequent document extraction “falls back” to the alignment-based extraction from each Document Extraction Set. The described bi-directional use of content matching to generate LLM prompts, and then using that matching process to validate an abstracted prompt's output, provides a feedback loop useful in reducing errors, especially with respect to LLM hallucinations.

### DETAILED DESCRIPTION OF PREFERRED EMBODIMENT

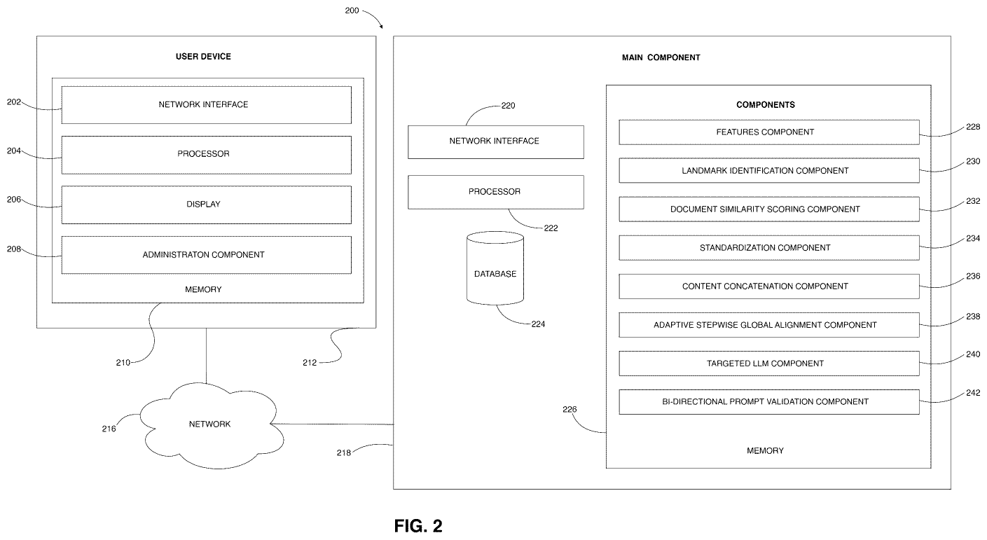

In a preferred embodiment of the invention, a method for extracting content from electronic documents is disclosed. The method is implemented using a data extraction system 200 depicted in FIG. 2. Referring to FIG. 1, the method 100 is initiated when a target digital document is received 102. Upon receipt, the system 200 parses the document into a plurality of Content Items. For each Content Item, a comprehensive feature profile is generated by accessing an adaptive features database 130. These features are subsequently ranked by significance, for instance, by calculating their Shannon entropy. Utilizing the features with the highest rank by Shannon entropy, the system 200 identifies a set of Landmarks within the document 104. In some aspects, Landmarks are defined as distinctive, machine-readable content with a globally unique location, which may include unique strings, structural elements, or specific formatting patterns.

Following Landmark identification, the system 200 accesses a datastore that contains a plurality of Document Extraction Sets 126. The system 200 then iteratively compares these Document Extraction Sets 106 to the target document. Each set within the datastore includes a reference document, referred to as a First Content Document. The system 200 compares the Landmarks identified in the target document with intersecting Landmarks from each First Content Document to determine the closest match.

To quantify the degree of similarity, the system 200 calculates a spatial distortion score as a component of the comparison 106. This calculation involves identifying common unique content, or intersecting candidate Landmarks, between the incoming target document and the First Content Document. Subsequently, positional outliers among the identified Landmarks are removed using a Mahalanobis Distance calculation. Finally, a Simplified Procrustes Distance is performed on the remaining Landmarks to compute a final score, which quantifies the geometric similarity or dissimilarity between the spatial arrangements of the Landmarks in the two compared documents.

The system 200 then evaluates the highest similarity score, which corresponds to the lowest Procrustes score, against a predetermined threshold to match a document extraction set 108. If the score is determined to be the lowest among all compared documents within a document extraction set Grouping and is also below a pre-specified threshold, the document is flagged as a match. The document extraction set containing the best-matching First Content Document is then retrieved and passed, along with the target document, to an alignment stage 110.

If the calculated score is above the pre-specified threshold, the document is flagged as a new, unmatched document. In this case, the system proceeds to create a new Document Extraction Set 120. This new set is configured according to user-provided specifications for the content to be extracted, which may include targets, labels, transformations, and formatting rules 122. Based on these specifications, content is extracted 112, validated 114, and formatted 116, after which the extracted content is saved. The newly created Document Extraction Set, containing all specifications, is saved to the document extraction sets database 126 for subsequent use.

For a matched pair of documents, the system 200 performs an adaptive, stepwise global alignment 110. As disclosed in preceding embodiments, the alignment process 110 is guided by the previously computed and ranked features. The alignment is initiated by seeding, wherein initial Landmarks are established using high-confidence, distinct, matches between Content Items in documents to ground the alignment between documents globally. These Landmarks are identified either by using intersecting content with the highest Shannon entropy or through a heuristic method, such as identifying content that is unique within each document and also intersects between both documents.

An illustrative matching process between two candidate Content Items is provided in the tables below. Table 2 shows the feature profiles for a Content Item from a First Content Document and a Content Item from a Second Content Document.

TABLE 2

| Feature | Content Item from Document 1 | Content Item from Document 2 |
|---|---|---|
| Value | 1,301,987 | 1,314,881 |
| Type | Numeric, hierarchical | Numeric, hierarchical |
| Font | Garamond | Garamond |
| Size | length: 0.065, height: 0.020 | length: 0.069, height: 0.021 |
| Semantic | “Is second value in formula2” | “Is second value in formula2” |
| Feature | | |
| Positional | “On same line as ‘Ending Market | “Is on same line as ‘Ending Market |
| Feature | Value’” | Value’” |
| Spatial Vector | 0.26, 0.08, 0.52, 0.12, 0.22, 0.18 | 0.27, 0.08, 0.51, 0.12, 0.24, 0.20 |

Table 3 describes the stages of the matching process for the two Content Items detailed in Table 2. The process includes a hierarchical deterministic matching stage followed by a non-deterministic similarity scoring stage.

TABLE 3

| Stage | Step | Comparison | Result |
|---|---|---|---|
| 1. Deterministic | First Step - | 1,301,987 vs. | Fail. Literal values are different. |
| Matching | Test by Value | 1,314,881 | |
| | Second Step - | d, ddd, ddd vs. | Pass. The numeric pattern matches. |
| | Test By | d, ddd, ddd | The pair proceeds to non- |
| | Format | | deterministic analysis. |
| 2. Non- | Size Similarity | Euclidean distance of | Pass. The calculated distance of |
| Deterministic | | (0.065, 0.020) vs. | approximately 0.00412 is below |
| Scoring | | (0.069, 0.021) | the predefined tolerance threshold. |
| | Spatial Vector | Euclidean distance of | Pass. The normalized distance of |
| | Similarity | Hough-Inspired KNN | 0.0455 is below its predefined |
| | | vectors | threshold. |

Because the two Content Items successfully passed the deterministic feature check and their non-deterministic features yielded the lowest distance scores among all other potential candidates while remaining within the predetermined thresholds, the pair is confirmed as a match.

In a preferred embodiment, unmapped Content Items are LLM or human labeled. If Content Items are not aligned by the adaptive, stepwise global alignment, 110, such content is flagged. If such flagged content is desired to be extracted, the system 200 modifies the document extraction set 120 via a human or the prompting of an LLM where such content is labeled, and additional specifications are provided to identify such content, create validations for it and specify any transformations to be applied to such extracted content along with format.

Regardless of modification in 120, in the case that any validation fails validation, this is noted in a file that is saved to the structured extracted content database 124. Thus, this database stores full extracted content, partially extracted content, or a file specifying that no content was able to be extracted, along with the results of the validations that failed.

In a preferred embodiment, content is aligned, and extracted and which passes validation is moved to a process of transformation and formatting. This part of the system, referred to as transform and format extracted content 116, is labeled. This process uses the specifications from the matched document extraction set to apply any desired transformations, and output for the final, structured data which is then saved in the structured extracted content database 124. For example, a document extraction set may specify that dates are to be converted to desired format.

In a preferred embodiment, from time to time, the system 200 executes a process called abstracted prompt generation 118 which generates a prompt using 1) the top n ranked features, 2) past extraction results and 3) past documents from one or more document extraction sets to prompt an LLM to generate a new, generalized data extraction prompt which can be utilized across multiple document extraction sets. The new prompt can then be used in the future to extract content by prompt 128. A bi-directional validation is performed by testing the newly generated prompt against the output derived from the results from the alignment-based extraction process. This feedback loop allows the system 200 to continuously refine its models and adapt to new document variations. Both successful and unsuccessful prompts are stored in the document extraction set 126 for future reference.

According to an exemplary embodiment, the present invention is implemented within the data extraction system 200, configured to perform the adaptive content extraction methods described herein. As illustrated in FIG. 2, the system 200 comprises a main component 218 communicatively coupled with a user device 212 via a network 216.

The user device 212 provides an interface for an administrator or user to interact with the system 200. The user device 212 includes a processor 204, memory 210, a network interface 202 for communication over the network 216, and a display 206. The memory 210 stores an administration component 208, which comprises instructions that, when executed by the processor 204, provide a user interface for submitting documents to the system, specifying or modifying document extraction sets, defining target content and formatting rules, and reviewing extracted data presented on the display 206.

In various aspects, the main component 218 is the central processing apparatus of the system. It includes at least one processor 222, a network interface 220, a database 224, and a non-transitory computer-readable memory 226. The memory 226 stores a plurality of executable software components which, when executed by the processor 222, are configured to perform the core functionalities of the invention. The processor 222 is a specially programmed or configured processor for executing the steps of the method. These executable software components include:
(a) A features component 228: This component parses documents to generate a comprehensive feature profile for each Content Item. The features component 228 is configured for creating both deterministic and non-deterministic features and for calculating the Shannon entropy of each feature type to create a ranked list for guiding the alignment process.
(b) A Landmark identification component 230: This component uses the highest-ranked features from the features component 228 to identify and match distinct, high-confidence Landmark Content Items that serve as a structural foundation for alignment between documents. The Landmark identification process uses Euclidean distance to verify the similarity of positioning of Candidate Landmarks between documents and removes outliers from Candidate Landmarks within documents using a Mahalanobis distance calculation exceeding a threshold.
(c) A document similarity scoring component 232: This component performs the shape consistency analysis (point consistency), such as Simplified Procrustes Distance, on the spatial arrangement of Landmarks to calculate a similarity score between documents and route an incoming document to the most similar First Content Document (above a predetermine threshold) in a Document Extraction Set
(d) A Standardization Component 234: This component performs the adaptive hierarchical standardization of Content Items to generalize them into a hierarchy of abstract categories. It maps a specific data value to a structural class and then to a broader semantic class using a data store of transformation rules. It also standardizes values based on external data sources, membership in known choice sets, or predicted values.
(e) Content Concatenation Component 236: This component compares Content Items between documents to identify instances where a single item in one document might correspond to two or more adjacent items in the other document, such as “Account Number” being split into “Account” and “Number”. When such matches are identified, the component concatenates the split Content Items.
(f) Adaptive, Stepwise Global Alignment Component 238: This component performs the adaptive, stepwise global alignment of Content Items. It matches more specific (higher entropy) and unique Content Items before matching less specific ones. The process is iterative, using a ranked feature list from highest to lowest entropy. It utilizes both deterministic and non-deterministic features, along with spatial relationships to previously matched items, to progressively refine matching and enhance accuracy.
(g) Targeted LLM Component 240: This component manages all strategic interactions with external Large Language Models (LLMs) via the network interface 220. Its functions include validating new content, generating labels for ambiguous items, creating abstracted extraction prompts, and handling constrained labeling of reordered content by assigning labels from a predefined canonical set. It tests the accuracy of an LLM-generated prompt by comparing its output against the results produced by the adaptive, stepwise global alignment component 238.
(h) Bi-directional Prompt Validation Component 242: This component implements a feedback loop to validate LLM-generated prompts. It tests the accuracy of a new prompt by comparing its output against the results produced by the adaptive, stepwise global alignment component. This process helps reduce errors, particularly those related to LLM hallucinations.

The user device 212 is a computing device including at least one processor, a memory, and a network interface. Examples of the user device 212 include, but are not limited to, a personal computer (“PC”), a desktop workstation, a laptop, a notebook, a smartphone, a wearable computing device (such as a smartwatch, a smart glass, or a virtual reality head-mounted display), a personal digital assistant (“PDA”), an electronic-book reader, a game console, a set-top box, a consumer electronics device, a smart home appliance, a server computer, or any other computing device configured to communicate with the main component 218 of the data extraction system via a network. The network 216 is a data communication network, which can be a local-area network (“LAN”), a wide-area network (“WAN”), a cellular network, a satellite network, or any other networking topology, including the Internet, that facilitates communication between the user device 212 and the main component 218.

What is claimed is:

1. A computer-implemented method for extracting content from electronic documents, the method comprising:
(a) receiving a first electronic document and a second electronic document;
(b) generating a comprehensive feature profile for each of a plurality of content items within the first and second documents, the feature profile comprising a set of deterministic and non-deterministic features;
(c) calculating a Shannon entropy score for each feature to rank the features by their discriminating power;
(d) identifying a set of Landmarks common to both documents by matching intersecting content items with the highest-ranked features, wherein the Landmarks are globally distinct within each document and serve as anchor points for alignment;
(e) performing an adaptive, stepwise global alignment of unmatched content items between the documents, comprising:
(a) iteratively matching content items in a sequence guided by their feature ranking, from highest-entropy features to lowest-entropy features;
(b) for each match, using deterministic features to identify a plurality of candidate matches and then using non-deterministic features to select a single, geometrically coherent match from the candidates;
(c) utilizing the spatial relationships of progressively matched items to refine and enhance the accuracy of subsequent matches;
(f) identifying one or more target content items for extraction from the first document; and
(g) extracting and outputting content from the matched content items in the second document in a structured format.

2. The method of claim 1, wherein identifying a set of Landmarks further comprises applying a heuristic method to identify Content Items that are distinct, such as Content Items occurring one or two times, having locations that exceed a predetermined Euclidean distance within each document, and also share a similar spatial location between documents.

3. The method of claim 1, wherein the deterministic features comprise one or more of:
(a) an exact value of the Content Item, or a standardized variant thereof as determined by one or more of hierarchical standardization, external value standardization, relationship value standardization, predicted standardization, Choice Set standardization and the like;
(b) a relational feature describing a mathematical or logical relationship between a plurality of Content Items, which is represented as a one-hot encoded vector;
(c) an evidence-based feature that represents a formulaic relationship updated by new evidence discovered in a document; and
(d) a converted feature wherein a non-deterministic spatial metric has been transformed into a discrete Boolean feature.

4. The method of claim 1, wherein the non-deterministic features comprise one or more of:
(a) a size of the Content Item;
(b) a Euclidean distance to other nearby Content Items; or
(c) a distance and angle relative to one or more Landmarks.

5. The method of claim 1, wherein the stepwise global alignment of step (f) is a two-stage process comprising:
(a) using the deterministic features to identify an initial plurality of candidate Content Item matches from the second electronic document which match a Content Item from the first electronic document; and
(b) using the non-deterministic features, including spatial metrics relative to the Landmarks, to select a single correct match from the plurality of candidate Content Item matches.

6. The method of claim 5, wherein using the non-deterministic features further comprises applying a Hough-Inspired KNN Similarity to score the geometric coherence of each candidate match based on its directed angle and distance to a plurality of Landmarks.

7. The method of claim 1, wherein the set of features for each Content Item further includes a relationship value standardization feature that is a determined by the processors to describe a role in a discovered relationship, and wherein said relational feature is represented as a one-hot encoded vector.

8. The method of claim 1, further comprising standardizing a Content Item by a value and assigning a class identifier thereto, wherein said standardization is performed by a hierarchical standardization process that progressively generalizes the Content Item into a hierarchy of increasingly abstract categories.

9. The method of claim 1, wherein the content in the First Content Document is matched to concatenated content in a second electronic document or second electronic document variant.

10. The method of claim 1, wherein the set of features further includes a knowledge-based feature indicating membership in a known historical choice set, and wherein said historical choice set is represented using a one-hot encoding scheme.

11. The method of claim 10, further comprising:
(a) upon identifying a Content Item in the second electronic document, that is a candidate for membership in a choice set, providing the value for said candidate Content Item and existing members of the choice set to a Large Language Model (LLM); and
(b) based on the LLM's determination that the candidate Content Item is semantically related to the existing members—as distinguished from being lexically similar—automatically adding the candidate Content Item to the historical choice set in a data storage device.

12. The method of claim 1, further comprising:
(a) maintaining a knowledge base of hypothesized relationships, said relationships comprising a set of potential relational models applicable to a target set of Content Items;
(b) analysing a subsequent electronic document to identify new evidence that resolves an ambiguity in a specific hypothesis;
(c) updating the knowledge base by selecting a specific, correct relationship from the set based on the resolved ambiguity; and
(d) applying the selected specific relationship as a contextual relational feature to improve the accuracy of a subsequent stepwise global alignment.

13. A computer-implemented method for routing an incoming electronic document to the most similar First Content Document from a collection of stored First Content Documents, the method comprising:
(a) for each First Content Document in the collection, performing a comparison against the incoming document by:
(i) identifying a set of intersecting candidate Content Items between documents, defined as Landmarks, present in both the incoming document and the current First Content Document;
(ii) applying a Mahalanobis Distance to the normalized positions of the common Content Items to identify and remove one or more spatial outlier Content Items from the set; and
(iii) performing a consistency analysis on the location of the filtered set of non-outlier Landmarks by calculating a Simplified Procrustes Distance, wherein said score quantifies the similarity in the geometric arrangement of the Landmarks; and
(b) selecting the First Content Document that yields the lowest spatial distortion score that is below a predetermined threshold to serve as the reference document for subsequent content extraction; and
(c) creating a new Document Extraction Set if there are no First Content Documents that yield a spatial distortion score below a predetermined threshold.

14. A system for extracting content from electronic documents, the system comprising:
(a) a data storage device; and
(b) one or more processors, in communication with the data storage device, the processors configured to:
(i) store a reference electronic document comprising a plurality of reference Content Items, each having a set of features, wherein said set of features includes features from an adaptive hierarchical standardization process;
(ii) receive a new electronic document containing a plurality of new Content Items;
(iii) identify a set of high-confidence Landmarks common to both the reference and new electronic documents based on feature matching at a high level of specificity;
(iv) perform a stepwise global alignment of the new Content Items against the reference Content Items, using the Landmarks as a spatial basis for matching remaining Content Items to corresponding reference Content Items; and
(v) based on said alignment, extract content from new Content Items that correspond to predefined target Content Items in the reference document.

15. The system of claim 14, wherein the one or more processors are further configured to utilize a Large Language Model (LLM) to generate descriptive labels for Content Items in the new electronic document by analyzing text within the document that is proximate to said Content Items.

16. The system of claim 14, wherein the set of features further includes relational features discovered between Content Items, including mathematical or structural relationships, said relational features being represented as one-hot encoded vectors for use in the stepwise global alignment.

17. The system of claim 14, wherein the one or more processors are further configured to:
(a) generate a plurality of extraction results from different electronic documents;
(b) provide the extraction results to a Large Language Model (LLM) to generate a generalized extraction prompt; and
(c) store the generalized extraction prompt in the data storage device for use in processing future documents.

18. A non-transitory computer-readable medium having instructions stored thereon, which, when executed by one or more processors, cause the one or more processors to perform a method comprising:
(a) for each of a plurality of Content Items in a first electronic document, generating a feature profile comprising deterministic features and non-deterministic features;
(b) for each feature type, calculating a Shannon entropy score and ranking the feature types from most discriminating to least discriminating;
(c) receiving a second electronic document;
(d) identifying a set of Landmarks that are common to the first and second electronic documents by matching based on the highest-ranked feature(s); and
(e) performing an iterative stepwise global alignment of remaining Content Items, wherein each iteration uses the next-ranked feature type, in addition to other features, and spatial relationships to previously aligned items to identify matches, and wherein content corresponding to predefined target items is extracted from the second document based on the alignment.

19. The method of claim 1, further comprising:
(a) identifying a second electronic document variant, wherein a rank order of vertical or horizontal coordinates of at least two corresponding Landmarks is inconsistent compared to the First Content Document;
(b) providing a predefined canonical label set to a Large Language Model (LLM) as a constraint; and
(c) employing the LLM to assign a label from the predefined canonical label set to one or more Content Items in the second electronic document variant to facilitate the stepwise global alignment.
